(19) United States
(12) Patent Application Publication
(10) Pub. No.: US 2010/0000417 A1
(43) Pub. Date: Jan. 7, 2010

(54) COUNTERTOP APPLIANCE COOKING CONTROL UNIT WITH EJECTION FEATURE

(76) Inventors: Joel TETREAULT, Roswell, GA (US); Kevin O'Doherty, Hong Kong (CN); Lee Chak Por, Hong Kong (CN)

Correspondence Address: GARDNER GROFF GREENWALD & VILLANUEVA, PC, 2018 POWERS FERRY ROAD, SUITE 800, ATLANTA, GA, 30339, US

(21) Appl. No.: 12/493,537

(22) Filed: Jun. 29, 2009

Related U.S. Application Data
(60) Provisional application No. 61/077,164, filed on Jul. 1, 2008.
(60) Provisional application No. 61/077,162, filed on Jul. 1, 2008.

(51) Int. Cl. A47J 36/00

(52) U.S. Cl. 99/325

(57) ABSTRACT

A cooking control unit for a kitchen-countertop appliance is configured to selectively engage the body of the appliance in operation and to selectively disengage from the appliance body for cleaning. The control unit includes an ejection mechanism that is operable to force the control unit away from the appliance body to cause the disengagement. The ejection mechanism can be related to a cooking selector configured to select a cooking parameter of the food to be prepared. For example, the ejection mechanism can include displacement members such as pins or cams and the cooking selector can include an ejection position. As the cooking selector is adjusted to the ejection position, the control unit is forced away from the body of the countertop appliance by the displacement members.

### CROSS-REFERENCE TO RELATED APPLICATIONS

This application claims the priority benefit of U.S. Provisional Patent Application Ser. No. 61/077,164, filed Jul. 1, 2008, and U.S. Provisional Patent Application Ser. No. 61/077,162, filed Jul. 1, 2008, which are hereby incorporated herein by reference.

### TECHNICAL FIELD

The present invention relates generally to kitchen-countertop appliances for food preparation and, more particularly, to detachable cooking control units for such kitchen-countertop appliances.

### BACKGROUND

Countertop appliances for food preparation are common in the modern kitchen. Specialty appliances such as waffle and pancake griddles, toasters, crock pots, woks, grills, blenders, can openers, and small ovens all compete for space on countertops.

In many countertop appliances for cooking, the cooking controls are provided in a separate unit that can be engaged and disengaged from the body of the appliance. This design is used to facilitate clean-up of the appliance after cooking, as the electronics of the control unit should not be exposed to water or cleaning agents. The cooking control unit is designed to positively engage the body of the appliance and provide electrical power to the appliance (e.g., the heating elements). Typically, the cooking control unit has a temperature control, which is used to select the heating level of the food to be prepared. Other electronic controls may be present in the cooking control unit such as temperature probes and thermostats.

Prior to operation, the cooking control unit is mounted to the body of the appliance. Typically, a temperature probe rod on the control unit is inserted into a corresponding opening in the body of the appliance, and the control unit and the appliance body are forced together until a positive engagement occurs. After cooking is completed, the control unit must be removed from the appliance body to facilitate the cleaning of the appliance. At this point the appliance may still be quite hot from the cooking operation, and the forcible removal of the cooking control unit can be problematic. Two hands are required, one to hold the appliance body in place and one to pull the control unit free. This assembly and disassembly operation can be difficult, even dangerous, for some cooks, especially when the appliance is still hot, and does not provide the optimum user experience in cooking with the appliance.

Accordingly, it can be seen that needs exist for a kitchen-countertop appliance with an improved cooking control unit that is easily installed on and removed from the appliance. It is to the provision of solutions meeting this and/or other problems that the present invention is primarily directed.

### SUMMARY

Generally described, the present invention relates to cooking control units for countertop appliances, the control unit configured to releasably mount to the body of the appliance and including an ejection mechanism that facilitates the easy removal of the control unit. The cooking control unit can be incorporated in a variety of different countertop cooking appliances such as waffle and pancake griddles, toasters, crock pots, woks, grills, and small ovens.

In an example embodiment, the cooking control unit includes a cooking selector configured to select the cooking level of the food to be prepared, with the cooking level selectable by a user by physical movement of a control knob to a position in a cooking parameter range. The cooking selector is further configured for the control knob to be physically moveable to an ejection position. As the cooking selector is moved to the ejection position, the cooking control unit is forced away from the body of the countertop appliance by an ejection mechanism.

In one aspect, the control knob of the cooking selector can be moved from an initial position in one direction to select a cooking temperature level, and from the initial position in an opposing direction to the ejection position. The initial position can be an “off” position or a minimum temperature setting of the unit. For example, the cooking selector can be provided with a rotary dial control knob that is rotated clockwise from the initial position to select a cooking temperature level and rotated counter-clockwise from the initial position to the ejection position. In an alternative embodiment, the cooking selector can be provided with a linearly sliding control knob that is linearly slid to the right (or up) from the initial position to select a cooking temperature level and linearly slid to the left (or down) from the initial position to the ejection position. And in another alternative embodiment, the control unit can include a control knob or actuator (e.g., a pushbutton) that is separate from the cooking selector.

In another aspect, the ejection mechanism includes one or more ejection pins, cams, and/or cam-and-follower mechanisms that force the cooking control unit away from the countertop appliance body. For example, a drive pin can be operably connected to and moved along with the control knob, and a cam surface can be integral with a translational sliding member. Movement of the control knob to the ejection position forces the pin to move along the cam surface, which forceably moves the sliding member in a translating motion, which in turn drives an ejector to force the cooking control unit away from the appliance body. Alternatively, the sliding member can be connected to and moved along with the control knob so that movement of the sliding member also moves the ejector, which then forces the cooking control unit away from the appliance body.

In another example embodiment, there is provided a method of disengaging a cooking control unit from a countertop appliance. The cooking control unit is configured to releasably engage the body of the appliance in operation. Also, the cooking control unit includes a cooking selector configured to select the cooking level of the food to be prepared, with the cooking level selectable by a user by physical movement of a control knob of the cooking selector to a position in a cooking parameter range. The method includes physically moving the control knob to an ejection position so that, as the control knob is moved to the ejection position, an ejection mechanism forces the cooking control unit away from the body of the countertop appliance. The method can include moving the control knob from an initial position in one direction to select a cooking temperature level, and moving the control knob from the initial position in an opposing direction to the ejection position.

The specific techniques and structures employed by the invention to improve over the drawbacks of the prior art and accomplish the advantages described herein will become apparent from the following detailed description of example embodiments of the invention and the appended drawings and claims.

### BRIEF DESCRIPTION OF THE DRAWINGS

The accompanying drawings are not intended to be drawn to scale. In the drawings, each identical or nearly identical component that is illustrated in various figures is represented by a like numeral. For purposes of clarity, not every component may be labeled in every drawing.

FIG. 1 is front view of a first example embodiment of a cooking control unit for a kitchen countertop appliance, showing a rotary cooking selector with a series of temperature positions, an off position, and an ejection position.

FIG. 2 is an exploded perspective view of the control unit of FIG. 1, showing the major components thereof.

FIG. 3A is an exploded front perspective view of a rotary dial assembly of the control unit of FIG. 2.

FIG. 3B is a rear perspective view of the rotary dial assembly of the control unit of FIG. 3A.

FIG. 3C is a rear view of a portion of the rotary dial assembly of the control unit of FIG. 3A.

FIG. 4 is a rear perspective view of the rotary dial assembly of FIG. 2 mounted onto the front housing portion.

FIG. 5A is rear perspective view of the slider of the control unit of FIG. 2 showing the drive surfaces.

FIG. 5B is front view of the slider of the control unit of FIG. 5A showing the cam surface.

FIG. 5C shows the slider of the control unit of FIG. 5A with the rotary drive pin in the first portion of the cam surface.

FIG. 5D shows the slider of the control unit of FIG. 5A with the rotary drive pin rotated into the second portion of the cam surface and the slider translating downward.

FIG. 6A is a rear perspective view of the rotary dial assembly and the slider of FIG. 2 mounted onto the front housing portion.

FIG. 6B shows the rotary dial assembly, the slider, and the front housing portion of FIG. 6A, with the slider translating downward.

FIG. 7A is a side view of the control unit of FIG. 2, with the slider and the ejectors in their rest/cooking positions.

FIG. 7B shows the control unit of FIG. 7A, with the slider and the ejectors in their ejection positions.

FIG. 8A is a rear perspective view of the control unit of FIG. 7A.

FIG. 8B is a rear perspective view of the control unit of FIG. 7B.

FIG. 8C shows the control unit of FIG. 7A in use with a countertop appliance.

FIG. 8D shows the control unit of FIG. 7B in use with a countertop appliance.

FIG. 9A shows the slider and the rotary drive pin of the control unit of FIG. 5D in the ejection position.

FIG. 9B shows the control unit of FIG. 8B with the ejectors in the ejection position.

FIG. 9C shows the slider and the rotary drive pin of the control unit of FIG. 9A in the rest/cooking position.

FIG. 9D shows the control unit of FIG. 9B with the ejectors in the rest/cooking position.

FIG. 10 is front view of a second example embodiment of a cooking control unit for a kitchen countertop appliance, showing a linear cooking selector.

### DETAILED DESCRIPTION OF EXAMPLE EMBODIMENTS

The present invention relates to a kitchen-countertop appliance with a cooking control unit having an ejection mechanism for the easy removal of the control unit from the appliance body. The control unit has an attractive industrial design and a familiar operating methodology, and incorporates the ejection mechanism in an unobtrusive manner. The ejection mechanism is intuitive and easily operated. The ejection mechanism can be operated with a single hand and does not require human contact with the appliance body, which may still be hot from food preparation. In operation, the ejection mechanism drives the control unit away from the appliance (e.g., for the first few millimeters) and thus overcomes the friction lock between the control unit and the appliance body. The control unit can then be easily withdrawn from the appliance and cleaned/stored.

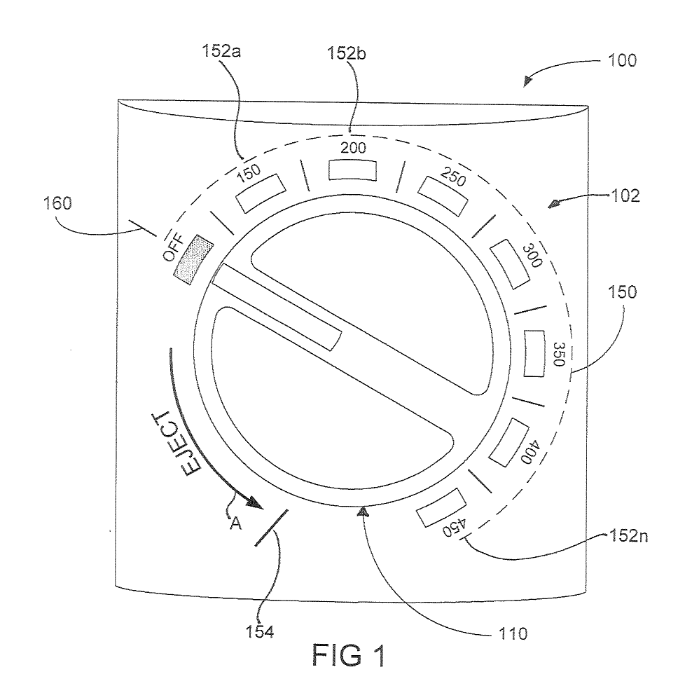

With reference to the figures, FIG. 1 is front view of a first example embodiment of a cooking control unit 100 for a kitchen countertop appliance. The cooking control unit 100 includes a cooking selector 102 for selecting a cooking parameter within a cooking parameter range of the appliance. In the depicted embodiment, the cooking selector 102 is configured for selecting the cooking temperature of the appliance. In other embodiments, the cooking selector is configured for additionally or alternatively selecting the cooking time, the level of cooking (e.g., rare to well done, low to high), a combination thereof, or some other cooking parameter associated with the appliance.

The cooking selector includes a rotary dial knob 110 with a temperature range portion depicted by dashed line 150. The temperature range portion 150 includes an “off” position 160 and a series of temperature positions 152a-n (collectively, the “temperature positions 152”) progressing along the range portion. The temperature positions 152 can be discrete positions (e.g., 250, 300, and 350 degrees) or the temperature range portion 150 can be a continuous scale such that the user can set the temperature to intermediate positions between the temperature positions (e.g., 275 and 325 degrees). The cooking temperatures of the appliance corresponding to each of the temperature positions 152 can be displayed around the periphery of the dial knob 110 in the temperature range portion 150. The user selects a desired cooking temperature by rotating the dial knob 110 clockwise from the off position 160 to the desired cooking temperature position 152 in the temperature range portion 150. When the preparation of food is completed, the appliance can be switched off by rotating the dial knob 110 counterclockwise back to the off position 160.

The rear portion of the control unit 100 includes a temperature probe 104, electrical connections (not shown), and a lock component (not shown). The electrical connections connect to mating electrical connections of the appliance body to supply power from the appliance (which includes batteries or a power cord for house voltage) to the control unit. The temperature probe is received in an aperture in the body of the appliance. And the lock component releasably couples to a mating lock component of the appliance body. The control unit and appliance body lock components can be friction-lock components that lock together with a friction fit (e.g., snap-fit or detent couplings), as is common for these appliances. The friction lock components can be provided in any of a number of forms, for example, for frictional engagement between the temperature probe and the probe aperture, the rear portion of the control unit and the front portion of the appliance body, the electrical connections of the control unit and the appliance body, or a combination thereof. Alternatively, the lock components can be provided by bayonet-type coupling components or by other conventional mating releasable lock components, with the ejection mechanism producing a lifting, twisting, or other movement of the control unit before producing the withdrawing movement. Also, the appliance body can have a recess that receives the rear portion of the control unit.

To mount the control unit to the appliance body, the user inserts the temperature probe into the body probe aperture and presses the control unit against the body until the electrical connections mate and the friction lock components lock together. There is only a high friction between the mating lock components in the last portion (e.g., the final few millimeters) of the control unit movement onto the appliance body. This high friction is what secures the control unit to the appliance body. But when the chef desires to remove the control unit from the appliance body, the chef must first manually overcome this friction lock, which can be difficult.

To mechanically overcome this high friction, the control unit includes an ejection mechanism. In the depicted embodiment, the cooking selector 102 of the control unit 100 includes an ejection position 154 positioned counterclockwise from the off position 160. The dial knob 110 cannot be rotated clockwise from one of the temperature positions 152 in the temperature range portion 150 to the ejection position 154. When the chef desires to remove the control unit 100 from the appliance body, the dial knob 110 is rotated counterclockwise from the off position 160 (in the direction of arrow A). As the dial knob 110 is rotated counterclockwise to the ejection position 154, the control unit 100 is forced away from the appliance body by other components of the ejection mechanism as described below. In an alternative embodiment, the ejection position is located clockwise from the off position and the temperature range portion 150 is located counterclockwise from it.

This configuration of the cooking selector 102, with the temperature positions 152 in one rotational direction, the ejection position 154 in the other rotational direction, and the off position 160 between them, provides a clear visual indication to the chef of the action he is undertaking. As a user interface, the cooking selector 102 is intuitive and correlates with the steps involved in the preparation of food in the appliance. In alternative embodiments, the cooking selector can be configured to eject the control unit from the appliance body by a motion of the dial knob that is different from the motion for selecting the temperature position (i.e., not just the same motion in a different direction). For example, the ejection mechanism can be configured so that upon applying a pushing or pulling force on the dial knob results in the control unit being forced away from the appliance body. In other alternative embodiments, the control unit can include an ejection button or switch that is not a part of the cooking selector but that is interlocked to the cooking selector so that the ejection mechanism only operates to eject the control unit if the cooking selector is set to the off position.

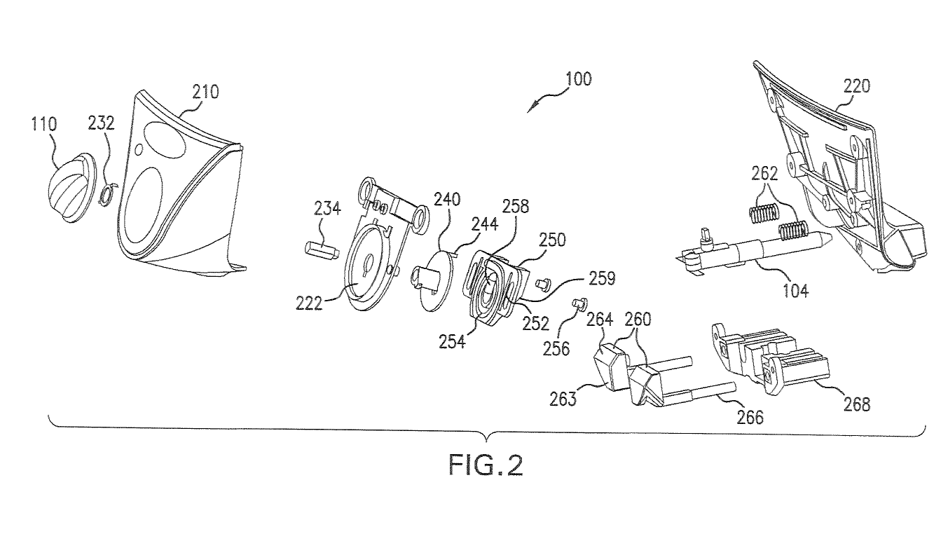

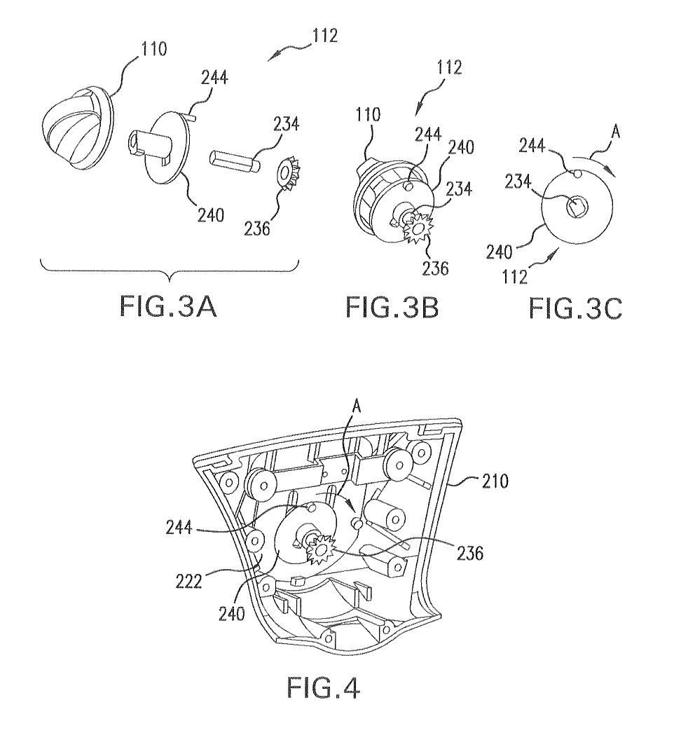

FIGS. 2, 3A-C, and 4 show the major components of the ejection mechanism of the cooking control unit 100. The control unit 100 includes a housing with a front housing portion 210 and a rear housing portion 220. The rotary dial knob 110 extends through an opening in the front housing 210, is connected to a knob shaft 234, and is supported on an inner mounting bracket 222. The inner mounting bracket 222 is mounted to the front housing portion 210 by fasteners (e.g., screws or bolts). The knob shaft 234 extends through an opening in the inner mounting bracket 222, extends through and is connected to a rotary drive support 240, and is connected to a gear 236. The knob shaft 234 is connected to the rotary drive support 240 in a manner that prevents rotation between the parts, for example, by mating keyed elements or mating non-circular geometrical surfaces. The gear 236 engages a cooperating gear (e.g., a rack or planetary gear) of the appliance body to control the cooking parameter of the appliance (e.g., to control heating elements in the appliance body). The rotary drive support 240 includes a rearwardly extending pin 244 or other protruding drive element (a boss, nub, arm, rod, bar, shaft, finger, or the like). The dial knob 110, the knob shaft 234, and the rotary drive support 240 are thus coaxially arranged and operably coupled together to form a rotary dial assembly 112 such that when the dial knob is rotated, the knob shaft and the rotary drive support 240 also rotate (see FIGS. 3A-C). The mounting bracket 222 permits rotary motion of the rotary dial assembly 112 but constrains it against translating motion. For example, the hole in the mounting bracket 222 through which the knob shaft 234 extends can be generally circular and the knob shaft 234 can be generally cylindrical where it extends through the bracket. The control unit 100 also includes a return spring 232 (e.g., a torsion spring) that biases the dial knob 110 from the ejection position 154 toward the off position 160, as described below.

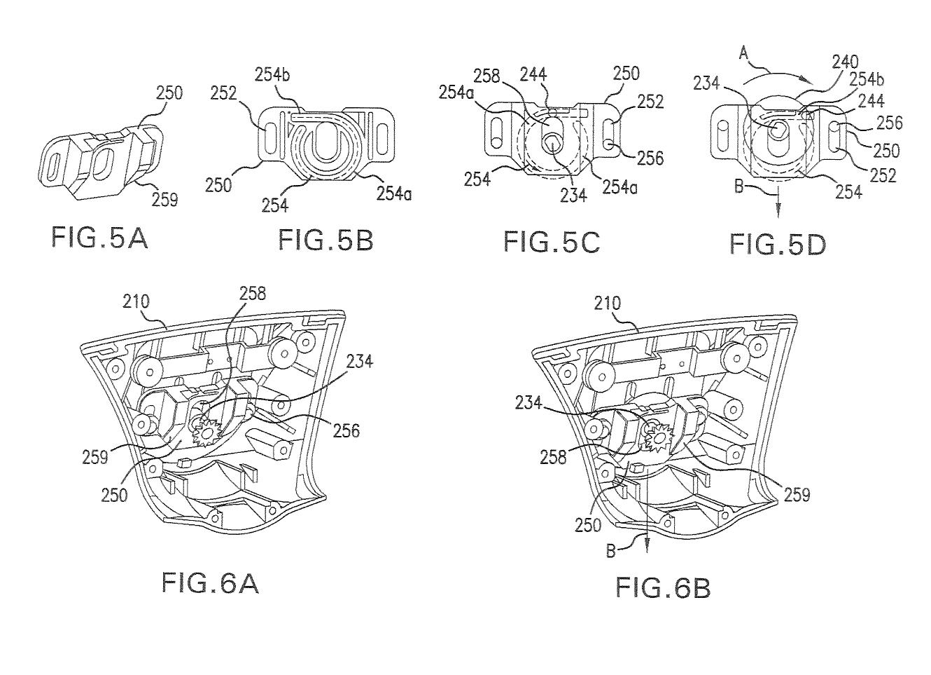

Behind and adjacent the rotary drive support 240 is a slider member 250. The slider 250 is constrained against moving in the same rotary motion and direction as the dial knob 110, but permitted to move in a lateral motion/direction. In the depicted embodiment, for example, the slider 250 is constrained against rotational movement but permitted to move linearly up and down by guide members 256 extending through elongated slots 252 in the slider (see FIGS. 5C and 5D). In alternative embodiments, the slider 250 is constrained against rotational movement but permitted to translate left and right, to translate in angular directions, to translate non-linearly, and/or to translate in other lateral (non-rotational) directions. The guide members 256 can be provided by fasteners (e.g., screws or bolts) that are also used to mount the slider 250 to the front housing portion 210. In addition, the slider 250 includes an elongated slot 258 through which the knob shaft 234 extends to permit linear up/down movement of the slider.

The slider 250 includes contact element such as a cam surface 254 that is engaged by the rotary pin 244 of the rotary drive support 240. The cam surface 254 can be formed by a channel or other opening in the slider 250 or by a ridge or other protrusion extending outwardly from the slider. Rotation of the rotary dial assembly 112 causes the rotary pin 244 to rotate while still engaging the cam surface 254, which causes the slider 250 to move linearly up or down, as described in detail below.

The slider 250 also has at least one translating drive surface 259 that engages and drives at least one translating contact surface 264 of at least one ejector 260 when the slider translates downward. In the depicted embodiment, the slider 250 includes two drive surfaces 259 that drive two contact surfaces 264 of two ejectors 260. The drive surfaces 259, the contact surfaces 264, or both are ramped such that when the drive surfaces are driven into engagement with the contact surfaces, the ejectors 260 are driven in a different direction, as described in detail below. The ramped drive surfaces 259 and/or contact surfaces 264 can have linear, curved, or other regular or irregular surfaces.

In addition, the ejectors 260 include elongated ejector pins 266 or other elongated displacement elements (rods, bars, shafts, fingers, or the like) that are received in and extend through guide openings in a thermostat support 268. In the depicted embodiment, each of the ejectors 260 has a base 263 from which the respective pin 266 extends and on which is formed the respective contact surface 264. The thermostat support 268 is mounted to the front housing portion 210 and supports the ejectors 260 (so that they are constrained from moving downward with the slider 250) and the temperature probe 104. Also, the ejector pins 266 are received in and extend through openings in the control-unit rear housing portion 220. Thus, rear ends of the ejector pins 260 can slide linearly in and out of the back of the housing 210 and 220 of the control unit 100.

In operation, when the control unit 100 is installed on a countertop appliance, the rear housing 220 of the unit 100 is adjacent to the appliance body. When the chef desires to disengage the control unit 100 from the appliance, he rotates the dial knob 110 of the rotary dial assembly 112 of the cooking selector 102 to the ejection position 154. The engagement of the rotating pin 240 and the cam surface 254 forces a downward displacement of the slider 250 into engagement with the ejectors 260. As the slider 250 is driven into engagement with the ejectors 260, the ejector pins 266 are forced rearward and out the back of the rear housing 220. The rear ends of the ejector pins 266 then bear upon the front surface of the appliance body, thereby forcing the control unit 10 away from the appliance.

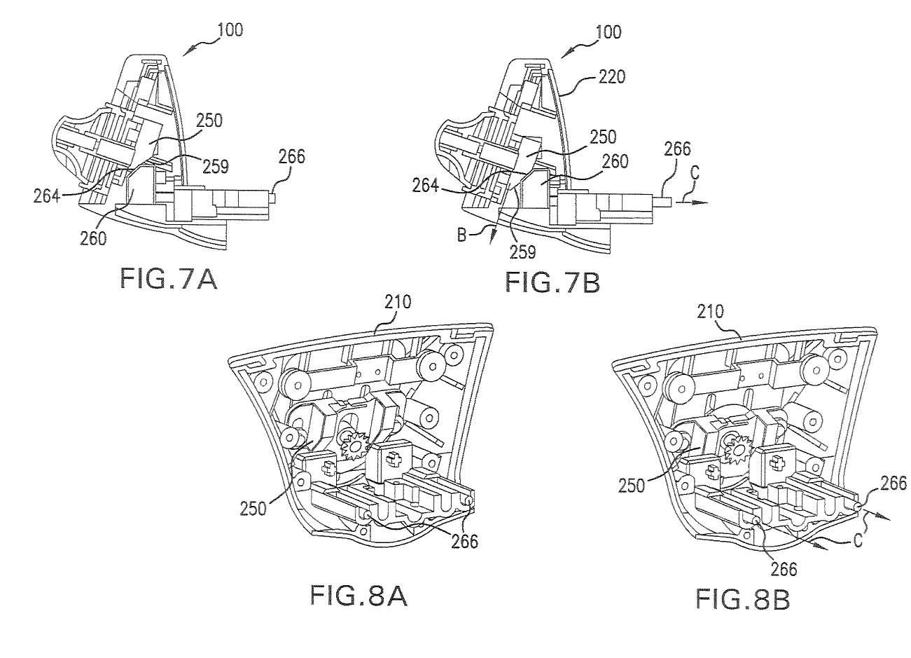

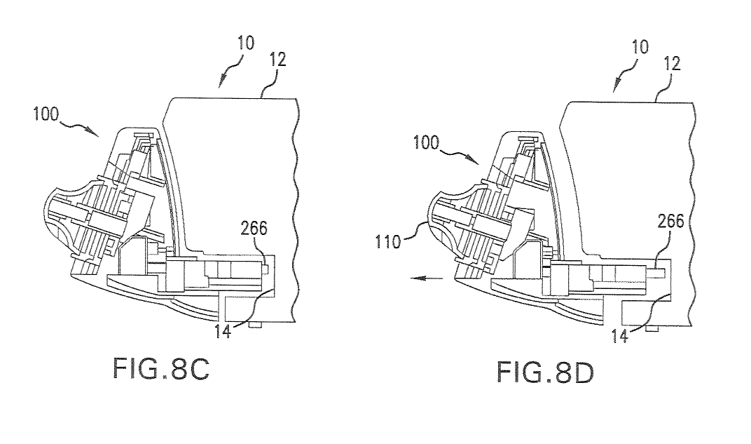

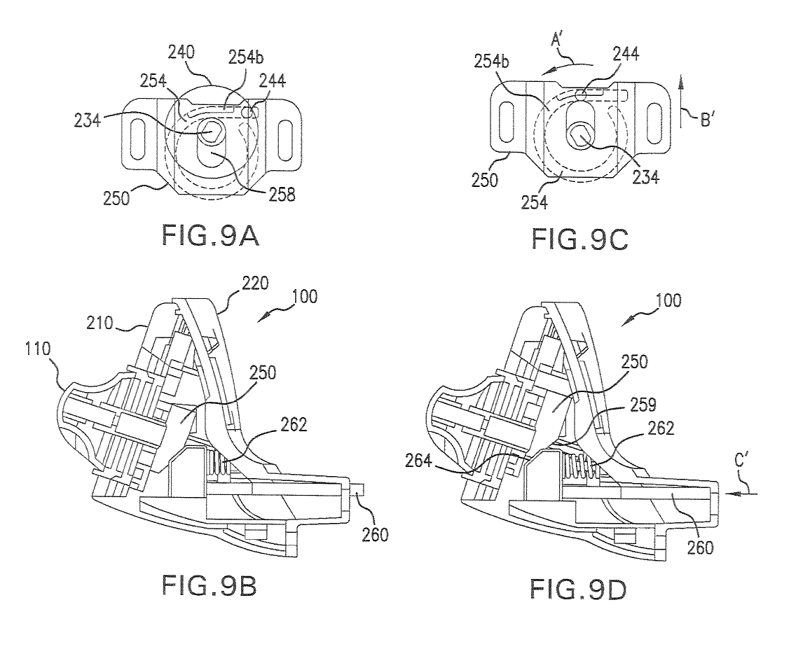

Additional structural and operational details of the control unit ejection mechanism will now be described with reference to FIGS. 5A-9D. In particular, FIGS. 5A-6B show the interrelationship between the rotary dial assembly 112 and the translating slider 250 when ejecting the control unit 100 from the appliance body, FIGS. 7A-8C show the interrelationship between the translating slider 250 and the ejectors 260 during the ejection, and FIGS. 9A-9DB show the relationship between these components as they return to their rest positions.

FIG. 5A shows the rear of the slider 250 with the translating drive surfaces 259. The drive surfaces 259 can be formed on ridges or other protrusions extending from the slider 250, as depicted. FIG. 5B shows the front of the slider 250 with the cam surface 254 including a first portion 254a and a second portion 254b. The first portion is generally circular (but does not form a complete circle), is centered at the rotational axis of the dial knob 110 (i.e., at the knob shaft 234), and matches the rotational path of the rotary pin 244. Thus, as shown in FIGS. 5C and 6A, during rotation of the dial knob 110 between the off position 160 (FIGS. 1 and 5C) and the temperature positions 152, the rotary pin 244 is rotated along the first cam surface portion 254a of the slider 250 without causing any linear up or down motion by the slider 250 (or any other movement by the slider). In addition, the cam surface 254 includes a second portion 254b that extends from and is in communication with the first cam surface portion 254a and is not centered at the rotational axis of the knob shaft 234. In the depicted embodiment, for example, the second cam surface portion 254b is provided by a linear cam surface extending generally tangentially from the generally circular first cam surface portion 254a. Thus, as shown in FIGS. 5D and 6B, during rotation of the dial knob 110 between the off position 160 and the ejection position 154 (in the direction of arrow A), the pin 244 is rotated along the second cam surface portion 254b of the slider 250. The rotary drive member 240 is constrained against translating motion and the slider 250 is constrained against rotary motion, as described above. So as the drive member 240 rotates (in the direction of arrow A) and the slider 250 does not, the pin 244 drives the second cam surface portion 254b to cause a linear downward motion by the slider (in the direction of arrow B).

Accordingly, the rotary pin 244 and the cam surface 254 function as a rotational-to-translational conversion assembly to convert the rotary motion of the dial knob 110 into the translating motion of the ejectors 260, which is then used to eject the cooking control 100 from the appliance body. As will be appreciated by those skilled in the art, the rotary pin 244 and the cam surface 254 form a conventional cam-and-follower assembly. As such, the position of the rotary pin 244 and the cam surface 254 can be reversed. Thus, the cam surface can be formed on the rotary drive support and the pin can protrude forwardly from the slider. This alternative configuration can be used to force the same displacement of the slider for a given rotation.

The translation of the slider 250 to drive the ejectors 260 will now be described. In FIGS. 7A and 8A, the slider 250 (and thus the ejectors 260) is at rest while the dial knob 110 is rotated through the temperature positions 152 and the off position 160 during the cooking process. In FIGS. 7B and 8B, rotation of the dial knob 110 from the off position 160 toward the ejection position 154 causes the slider 250 to translate downwardly in the direction of arrow B. The downward translation of the slider 250 moves the slider drive surfaces 259 into engagement with the contact surfaces 264 of the ejectors 260. The thermostat support 268 prevents the ejectors 260 from moving downward. So the further engagement of the drive surfaces 259 and 264 forces the ejectors 260 to translate rearwardly. Thus, the slider 250 and the ejectors 260 translate in different planes, for example, the plane of motion of the translating slider 250 and the plane of motion of the ejectors 260 can be generally perpendicular. Accordingly, the ejector pins 266 of the ejectors 260 are driven rearwardly toward and into contact with a bearing surface 14 of the body 12 of the appliance 10, as shown in FIG. 8C. When the dial knob 110 is rotated all the way to the ejection position 160, the ejector pins 266 are fully extended from the control unit 100 in their ejection positions, as shown in FIG. 8D. In this position, the control unit 100 has been pushed away from the appliance body 12 (see the directional arrow) far enough that the frictional forces of the lock components securing the control unit 100 to the appliance 10 have been overcome and the lock components are released from each other. The control unit 100 is now free of the appliance body 12 and can be taken away for cleaning, storage, etc.

The return of the ejection mechanism to its rest position will now be described. FIGS. 9A-B show the ejection mechanism in the ejection position, after the control unit 100 has been ejected from the appliance. The dial knob 110 is in the ejection position 160 (see FIG. 1), the rotary pin 244 is engaging the second/ejection portion 254b of the cam surface portion 254, the translating slider 250 is in its lowered ejection position, and the pins 260 are in their fully extended ejection positions protruding out the rear of the control unit 100.

The ejection mechanism includes at least one ejector return spring 262 (e.g., one spring for each ejector 206) that biases the ejector pins 260 forward into the control unit housing 210 and 220. The return springs 262 can be provided by the depicted helical compression springs or by other conventional spring elements such as leaf springs, elastomeric bushings, torsion or tension springs positioned for the same biasing effect, and/or the like. The return springs 262 can be positioned between the ejector bases 263 and the rear housing portion 220 so that when the ejectors 250 are in their rest/cooking positions the springs are not charged. But as the ejectors 260 are driven to their ejection positions, the return springs 262 are compressed and charged.

When the dial knob 110 is released, the charge stored by the return springs 262 causes the ejection mechanism to return to its rest/cooking position, as shown in FIGS. 9C-D. In particular, the return springs 262 drive the ejectors 260 back toward their rest/cooking positions, where the rear ends of the pins 266 are sufficiently retracted (to within the control unit housing 210 and 220 or to just outside of it) to prevent engagement with the appliance housing. As the ejectors 260 are driven forward in this manner, the ejector contact surfaces 264 now drive the slider drive surfaces 259 to force the slider 250 back upward. The translating slider 250 is constrained against rotary motion and the rotary drive member 240 is constrained against translating motion, as described above. So as the slider 250 moves upward (in the direction of arrow B′) but the drive member 240 does not, the second cam surface portion 254b drives the pin 244 to cause a rotational motion by the rotary dial assembly 112 (in the direction of arrow A′). Thus, the dial knob 110 is rotated back to the off position 160, and the control unit 100 is ready for reuse.

As will be appreciated by those skilled in the art, many variations of the ejection mechanism are possible. The use of the cam-and-follower mechanism provides a mechanical advantage of the rotary dial assembly over the translating ejector pins. The movement of the drive pin relative to the cam surface along the second cam surface portion can be about 10 to about 15 millimeters. The distance of the ejector-pin movement can be only a few millimeters. This produces a mechanical advantage of the rotary dial assembly over the ejector pins of approximately 3 to 5. A reasonable rotating pressure on the dial knob results in a high ejection force by the ejection pins on the appliance body. In an alternative embodiment, the drive element directly drives the ejector to an ejector ejection position, instead of indirectly driving it via the slider, so the ejection mechanism does not include the slider. Other configurations of camming mechanisms and linkage mechanisms are known to those skilled in the art and can be used to provide a mechanical advantage from the rotary dial assembly to the translating ejection pins. For example, the ejector displacement elements can be provided by cams instead of pins. The ejection cam would bear against the appliance body and be rotated by rotation of the dial knob toward the ejection position. In this embodiment, the position of the cam is changed within the mechanism chain to provide engagement directly by the rotary dial assembly and the slider is eliminated.

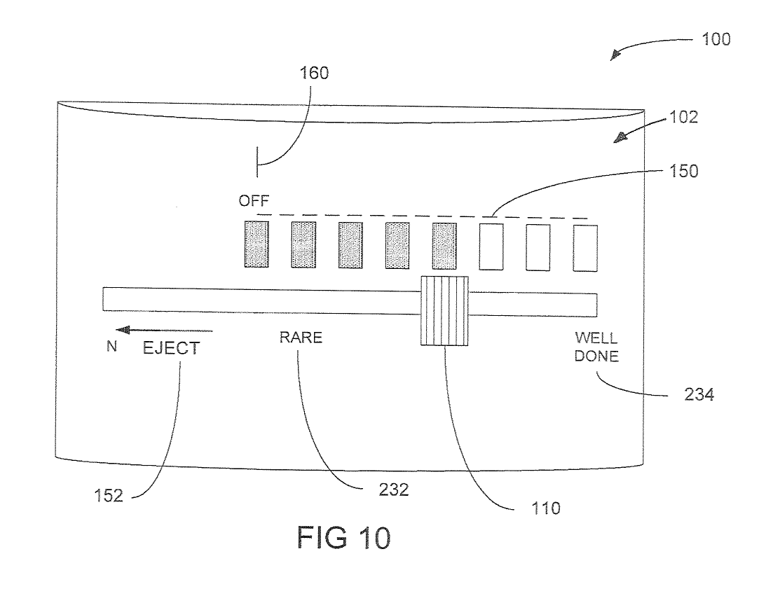

Referring now to FIG. 10, there is shown a cooking control unit 100 according to a second example embodiment. Similar to the first embodiment, the control unit 100 includes a cooking selector 102 including a control knob 110 movable between a range of settings including an off position 160, a series of doneness positions 150, and an ejection position 154. When the control knob 110 is linearly slid to the ejection position 154, an ejection mechanism of the control unit 100 forces the control unit away from the countertop appliance body. In this embodiment, however, the off, doneness, and ejection positions 160, 150, 154 are arranged in a linear fashion. Thus, the control knob 110 is provided by a slider knob instead of a dial knob. In addition, the doneness positions 150, which are displayed on the control unit 100, can range from “RARE” 232 to “WELL DONE” 234. Thus, the cooking parameter controlled by the cooking selector 102 is doneness instead of temperature.

In this embodiment, the ejection mechanism includes components configured to convert translating motion in one plane (from the linear slide knob) to translating motion in a perpendicular plane (for the ejector pins). The ejection mechanism can be configured to provide a high mechanical advantage to this conversion. For example, the ejection mechanism can include a pinion gear that is rotationally coupled to the slide knob shaft and that engages a rack gear only when the slide knob is slide between the off and ejection positions. The rack gear has a drive surface that engages and drives a contact surface of the ejectors to drive the ejectors to their ejection position. The return springs bias the ejectors back to their rest/cooking/retracted positions when then slide knob is released by the user. In alternative embodiments, the ejection mechanism includes another type of linkage or cam arrangement to produce the desired conversion of translating motions.

It is to be understood that this invention is not limited to the specific devices, methods, conditions, or parameters of the example embodiments described and/or shown herein, and that the terminology used herein is for the purpose of describing particular embodiments by way of example only. Thus, the terminology is intended to be broadly construed and is not intended to be unnecessarily limiting of the claimed invention. For example, as used in the specification including the appended claims, the singular forms “a,” “an,” and “the” include the plural, the term “or” means “and/or,” and reference to a particular numerical value includes at least that particular value, unless the context clearly dictates otherwise. In addition, any methods described herein are not intended to be limited to the sequence of steps described but can be carried out in other sequences, unless expressly stated otherwise herein.

While the claimed invention has been shown and described in example forms, it will be apparent to those skilled in the art that many modifications, additions, and deletions can be made therein without departing from the spirit and scope of the invention as defined by the following claims.

What is claimed is:

1. A cooking control unit for a countertop appliance, comprising:
a cooking selector including a rotary control knob movable between an ejection position and a series of cooking positions; and
an ejection mechanism including a rotary drive element, a translating slider member, and a translating ejector, wherein the rotary drive element is operably coupled to the rotary control knob, the slider includes a contact element and a drive surface, and the ejector includes a contact surface and a displacement element, wherein when the control knob is rotated to the ejection position the rotary drive element drives the slider contact surface to drive the slider in a slider translating motion to a slider ejection position, which drives the slider drive surface against the ejector contact surface to drive the ejector in an ejector translating motion to an ejector ejection position in which the ejector displacement element bears against the countertop appliance to displace the control unit from the appliance.

2. The cooking control unit of claim 1, wherein when the control knob is rotated to the cooking positions the rotary drive element does not drive the slider in the slider translating motion to the slider ejection position.

3. The cooking control unit of claim 1, wherein the cooking selector further includes an off position positioned between the cooking positions and the ejection position, wherein the control knob is rotatable from the off position to the cooking positions in a first direction and is rotatable from the off position to the ejection position in a second direction that is opposite from the first direction.

4. The cooking control unit of claim 1, wherein the ejection mechanism includes a cam-and-follower mechanism with the rotary drive element in the form of a pin or a cam surface and with the slider contact element in the form of the other of the pin or the cam surface.

5. The cooking control unit of claim 4, wherein the cam surface includes a first portion and a second portion, wherein the first portion is generally circular and is centered at a rotational axis of the rotary control knob, and wherein the second portion is in communication with the first portion and is not centered at the rotational axis of the rotary control knob.

6. The cooking control unit of claim 5, wherein the cam surface second portion is generally tangential to the generally circular cam surface first portion.

7. The cooking control unit of claim 4, wherein the rotary control knob is constrained from translating motion and the translating slider is constrained from rotary motion.

8. The cooking control unit of claim 1, wherein the slider drive surface, the ejector contact surface, or both, are ramped.

9. The cooking control unit of claim 1, wherein the slider and the ejector translate in different planes.

10. The cooking control unit of claim 1, wherein the ejector displacement element is in the form of a pin.

11. The cooking control unit of claim 1, further comprising a return spring that biases the ejector away from the ejection position.

12. The cooking control unit of claim 1 in combination with the appliance of claim 1.

13. A cooking control unit for a countertop appliance, comprising:
a cooking selector including a control knob movable between an ejection position and at least one cooking position; and
an ejection mechanism including a drive element and an ejector, wherein the drive element is operably coupled to the control knob and the ejector includes a displacement element, wherein when the control knob is moved to the ejection position the drive element directly or indirectly drives the ejector to an ejector ejection position in which the ejector displacement element bears against the countertop appliance to displace the control unit from the appliance, and wherein when the control knob is moved to the at least one cooking position the drive element does not directly or indirectly drive the ejector to the ejector ejection position.

14. The cooking control unit of claim 13, wherein the control knob is a linear slide.

15. The cooking control unit of claim 13, wherein the control knob is a rotary dial.

16. The cooking control unit of claim 15, further comprising a rotational-to-translational conversion assembly that converts the rotary motion of the control dial into a translating motion of the ejector.

17. The cooking control unit of claim 15, further comprising a translating slider member with a contact element and a drive surface, wherein the drive element is rotary and the ejector translates and includes a contact surface, and wherein when the control dial knob is rotated to the ejection position the rotary drive element drives the slider contact element to drive the slider in a slider translating motion to a slider ejection position, which drives the slider drive surface against the ejector contact surface to drive the ejector in an ejector translating motion to the ejector ejection position.

18. The cooking control unit of claim 15, wherein the ejection mechanism includes a cam-and-follower mechanism with the rotary drive element in the form of a pin or a cam surface and with the slider contact element in the form of the other of the pin or the cam surface, wherein the cam surface includes a first portion and a second portion, the first portion is generally circular and is centered at a rotational axis of the control dial knob, and the second portion is in communication with the first portion, generally tangential to the generally circular cam surface first portion, and not centered at the rotational axis of the control dial knob.

19. The cooking control unit of claim 13, wherein the cooking selector further includes an off position positioned between the at least one cooking position and the ejection position, wherein the control knob is moveable from the off position to the at least one cooking position in a first direction and is movable from the off position to the ejection position in a second direction that is opposite from the first direction.

20. The cooking control unit of claim 13 in combination with the appliance of claim 13.
